(19) United States
(12) Patent Application Publication
(10) Pub. No.: US 2024/0251281 A1
(43) Pub. Date: Jul. 25, 2024

(54) TECHNOLOGIES FOR SERVING DATA TRAFFIC ON ACCESS STRATUM RADIO BEARER

(71) Applicant: APPLE INC., CUPERTINO, CA (US)

(72) Inventors: Amr Abdelrahman Yousef Abdelrahman Mostafa, Munich (DE); Christian Hofmann, Munich (DE); Panagiotis Botsinis, Munich (DE); Sameh M. Eldessoki, Munich (DE); Tarik Tabet, Carlsbad, CA (US)

(73) Assignee: APPLE INC., CUPERTINO, CA (US)

(21) Appl. No.: 18/391,147

(22) Filed: Dec. 20, 2023

Related U.S. Application Data
(60) Provisional application No. 63/440,638, filed on Jan. 23, 2023.

(51) Int. Cl. H04W 28/02; H04W 72/50

(52) U.S. Cl. CPC H04W 28/0263; H04W 72/50

(57) ABSTRACT

The present application relates to devices and components, including apparatus, systems, and methods for serving data traffic on an access stratum (AS) radio bearer (RB) using independently configured bearer flows. Having their own resource sets, bearer flows remove the dependency of processing and transmission, and retransmission among different traffic flows assigned to the same AS RB.

### CROSS-REFERENCES TO OTHER APPLICATIONS

This application claims priority to U.S. Provisional Application No. 63/440,638, for “TECHNOLOGIES FOR SERVING DATA TRAFFIC ON ACCESS STRATUM RADIO BEARER,” filed on Jan. 23, 2023, which is herein incorporated by reference in its entirety for all purposes.

### TECHNICAL FIELD

This application generally relates to cellular communication networks and, in particular, to technologies for serving data traffic on access stratum radio bearer (RB).

### BACKGROUND

In a cellular wireless communication system, the network may provide resources for transmitting and receiving data traffic. When data traffic with different characteristics share the same resources, their transmission, and reception might become codependent. The dependency of data traffic of different traffic flows on one another can impact the latency and quality of service.

### BRIEF DESCRIPTION OF THE DRAWINGS

FIG. 1 illustrates a network environment in accordance with some embodiments.

FIG. 2 illustrates data traffic architecture in accordance with some embodiments.

FIG. 3 illustrates a radio bearer flow configuration in accordance with some embodiments.

FIG. 4 illustrates a radio bearer flow configuration in accordance with some embodiments.

FIG. 5 illustrates a signaling diagram in accordance with some embodiments.

FIG. 6 illustrates a signaling diagram in accordance with some embodiments.

FIG. 7 illustrates a radio bearer structure in accordance with some embodiments.

FIG. 8 illustrates packet headers in accordance with some embodiments.

FIG. 9 illustrates a signaling diagram in accordance with some embodiments.

FIG. 10 illustrates an operational flow/algorithmic structure in accordance with some embodiments.

FIG. 11 illustrates an operational flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

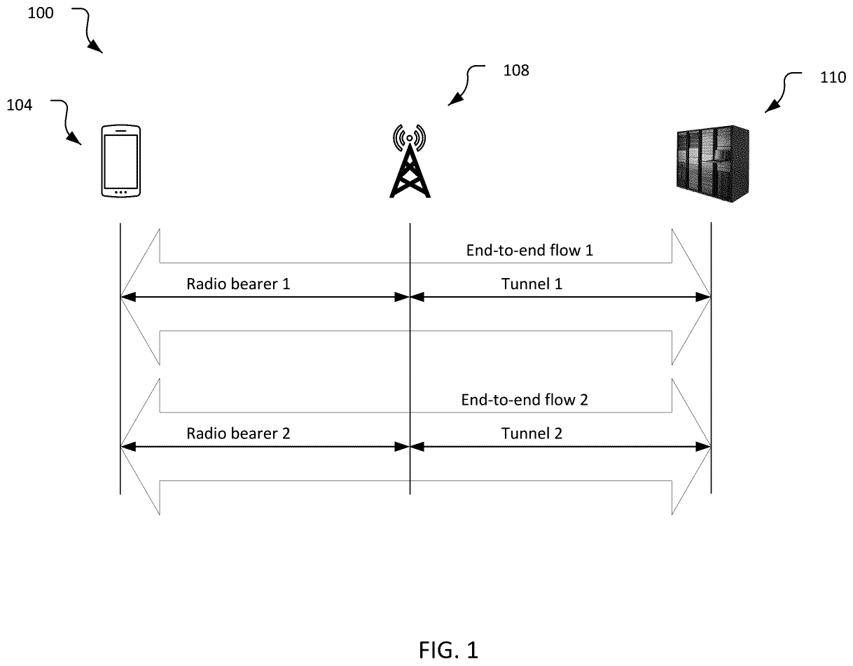

FIG. 1 illustrates a network environment 100 in accordance with some embodiments. The network environment 100 may include the UE 104 coupled with the base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The network environment 100 may include the core node (CN) 110 coupled (for example, communicatively coupled) with the BS 108. In some embodiment, the CN 110 is an evolved packet core (EPC) that provides converged voice and data on Fourth Generation (4G) or LTE networks. In other embodiments, the CN 110 includes a user plane function (UPF) that provides an interconnect between the mobile infrastructure, e.g., the UE 104 and base station 108, and the data network, e.g., the internet. The interface between the base station 108 and the CN 110 may be compatible with 3GPP TSs, such as those that define 5G NR or later system standards (e.g., 6G standards).

The network environment 100 may include end-to-end flows, for example, end-to-end flow 1. The end-to-end flow carries the data traffic. An end-to-end flow may also be referred to as traffic flow. A traffic flow may include data packets or data traffic exchanged between two ends of a communication connection. For example, in a video call, the UE 104 may send video packets to the CN 110 via the BS 108. The CN 110, in turn, forwards the video packets to the destination (not shown in the figure).

Similarly, the destination may send video packets to the UE 104. The CN 110 receives the video packets and sends them to the UE 104 via the BS 108. In one instance, the UE 104 may transmit and receive data. The data traffic associated with an application and exchanged between two ends of a communication connection may also be referred to as a service data flow (SDF). Therefore, an SDF may include both uplink and downlink data traffic.

In one instance, an end-to-end flow is abstractly analogous to a pipe for carrying data traffic. The pipe represents the resources allocated by the network to provide quality of service (QOS) for carrying data traffic to and from the UE 104. For example, a QoS flow is a pipe that provides a preconfigured QoS, e.g., latency or guaranteed bit rate. Several data traffic or SDFs may have similar quality of service (QOS) requirements and may be mapped to the same QoS flow. The UE 104 sends the data traffic to the BS 108, and the BS 108 forwards the data traffic to the CN 110. Similarly, the CN 110 receives the data destined for the UE 104 and sends them to the BS 108. The BS 108 forwards the data traffic to the UE 104.

In an instance of a communication system, an application (or an application layer) may generate the data for sending to a destination, e.g., a voice message. The data is processed through a protocol stack consisting of multiple layers, e.g., layer 2 (L2), including packet data convergence protocol (PDCP) and multiple access control (MAC) sublayers, and layer 1 (L1) or physical layer or transport layer. The data is exchanged between layers in logical channels in a transmitter or receiver. The transmitter protocol layer maps the data to transport channels for transmission between a transmitter and a receiver on a physical wired or wireless channel. The receiver maps the received data on the transport channel to the higher-layer logical channels.

One example of an L2 logical channel is a radio bearer, e.g., the radio bearer 1. The radio bearer provides a bi-directional logical channel between the UE 104 and the BS 108. A radio bearer may carry control signaling information. A radio bearer carrying control signaling may be referred to as a signaling radio bearer (SRB). A radio bearer may carry user plane data, e.g., application data or SDF. A radio bearer that carries user plane data is referred to as an access stratum (AS) radio bearer (RB) or a data radio bearer (DRB). The L2 logical channel between the BS 108 and the CN 110 may be referred to as a tunnel, e.g., tunnel 1. In one instance, the tunnel between the BS 108 and the CN 110 may be based on a general packet radio services (GPRS) tunneling protocol (GTP), e.g., GTP-U for transporting user data or GTP-C for transporting control signaling. The radio bearer 1 and tunnel 1 together form the end-to-end flow 1, providing a pipe for transferring data between the UE 104 and the CN 110.

The UE 104 may have more than one traffic flow, e.g., end-to-end flows 1 and 2. Additional AS RB can be added with specific configurations to achieve the QoS requirements of different QoS flows, e.g., by prioritizing one QoS flow over the other. Furthermore, each traffic flow may have its radio bearer and tunnel, e.g., radio bearer 1 and tunnel 1 in end-to-end flow 1 and radio bearer 2 and tunnel 2 in end-to-end flow 2. In one instance, radio bearer 1 may be an AS RB, and radio bearer 2 may be an SRB. In another instance, radio bearers 1 and 2 may be both AS RBs carrying user plan data with different requirements, e.g., QoS requirements. For example, radio bearer 1 may carry file transfer data, and radio bearer 2 may carry video conferencing data.

The UE 104 may request the BS 108 to initiate the configuration of an AS RB. The BS 108 assigns a static set of AS L2 resources to the AS RB, e.g., PDCP and radio link control (RLC) entities and PDCP and RLC state variables). The AS RB serves the data traffic using the L2 resources.

In one instance, more than one SDF or QoS flow can be mapped to the same AS RB. The network knows which flows are mapped to the AS RB and ensures that the AS RB is served according to its agreed end-to-end QOS requirements. Because the AS RB has only one set of L2 resources, AS RB cannot differentiate traffic from different SDFs or applications mapped to the same QoS flow. The AS RB can only differentiate among QoS flows, and there is no flexibility or control on the air interface below the QoS flow.

One way to provide differentiation among different SDFs is to assign each SDF to a different QoS flow, which requires configuring one QoS flow for each SDF or application. Configuring a QoS per SDF may result in wasted resources because SDFs are dynamic and may be created and terminated frequently, and some SDFs or applications are not required to transmit data in every cellular connection (e.g., RRC Connection). In addition, it is not easy to distinguish between the traffic coming out from the same SDF or application based on traffic filtering templates configured by the network.

Lack of flexibility and control in providing differentiation among traffic from different SDFs may negatively affect the receiver. For example, when two QoS flows are mapped to the same AS RB, the L2 layer at the receiver may block data delivery on a QoS flow because the packets related to another QoS flow are out of sequence or missing.

Lack of flexibility and control in providing differentiation among traffic from different SDFs may negatively affect the transmitter. For example, retransmission related to one QoS flow/SDF may cause a delay in the transmission of new packets from other QoS flows/SDFs mapped to the same AS RB. The delay in transmission may lead to data stall, e.g., RLC acknowledge mode (AM) transmitter Tx window stall, of any new packets of other QoS flows/SDFs mapped to the same AS RB. The data stall may also be called head-of-the-line (HOL) blocking.

Another example of an adverse effect on the transmitter is the starvation of low-load QoS flows. For example, a single highly loaded QoS flow may lead to starvation of new transmission from other low-load QoS flows. In another example, the SDF application data may starve the SDF control data. Having a QoS flow per SDF may lead to HOL blocking, longer and unpredictable latencies, jitter, and thereby unwanted effects on higher layers, e.g., transmission control protocol (TCP) acknowledgment (ACK) congestion, superfluous retransmissions, and slow starts.

Static assignment of L2 resources to a configured AS RB may cause limitations. For example, when the L2 resource set is statically assigned to a configured AS RB, the AS RB cannot be served by more than one AS L2 resource set. Having more than one L2 resource set may improve serving the traffic mapped to a single AS RB. Furthermore, static assignment of the L2 resource set may result in waste and underutilization of the L2 resource set. The waste occurs because, in some instances, data traffic is not required to be transferred on every configured AS RBs. In another example, traffic on different AS RBs may not be active at the same time, resulting in underutilization of the L2 resources set on the inactive AS RB.

Allowing an AS RB to include a variable set of independent data pipes, referred to as bearer flows (BFs), may provide a more flexible air interface for the AS RB. Each BF may be associated with its own dynamically configured L2 resource set. An L2 resource set, as used herein, may include state variables, transmission and receiver windows, sequence numbers, timers, and resources required by the cellular L2 data-plane layers (e.g., SDAP, PDPC, and RLC). The BF design may enable the protocol stack to differentiate between packets mapped to different BFs.

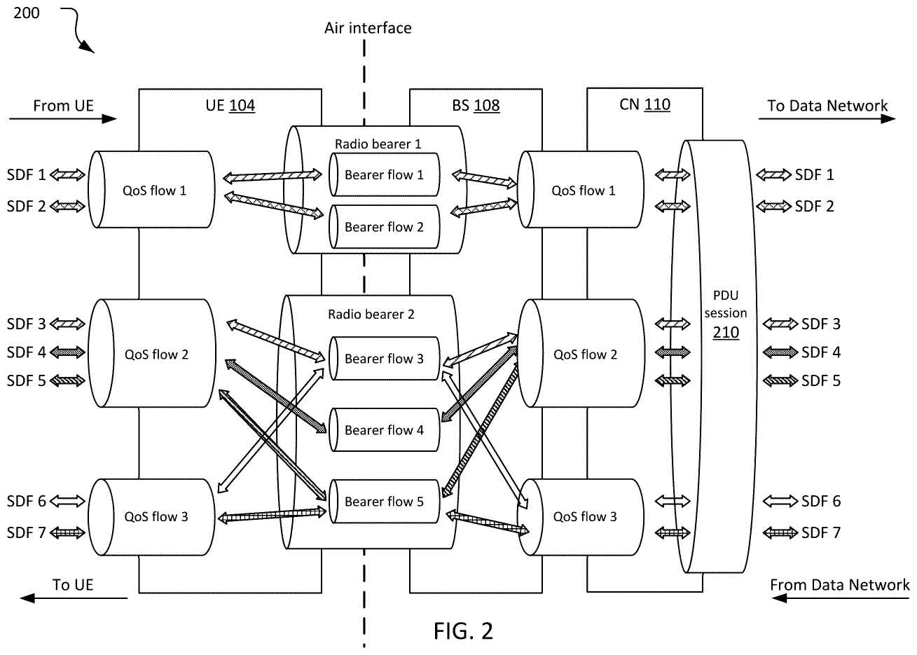

FIG. 2 illustrates data traffic architecture 200 in accordance with some embodiments. The data traffic architecture 200 may include the UE 104, the BS 108, and the CN 110. An air interface connects the UE 104 and the BS 108. In one example implementation, an N3 interface, defined in 3GPP TS 29.281 v.17.4.0 (Sep. 23, 2022), connects the BS 108 and the CN 110.

The UE 104 or the BS 108 may initiate a packet data unit (PDU) session 210. In one instance, when the UE 104 initiates a data transfer, the UE 104 requests the BS 108 to establish the PDU session 210. When the data is coming from the data network for the UE 104 for the first time, the network, e.g., the BS 108, configures the PDU session 210. The PDU session 210 may provide connectivity between applications at the UE 104 and the data network (DN). The PDU session 210 may carry multiple end-to-end traffic flows, e.g., traffic flows 1 and 2 in FIG. 1. The PDU session 210 may include an AS RB between the UE 104 and the BS 108 and a GTP-U tunnel between the BS 108 and the CN 110. In one instance, the logical connection between the BS 108 and the CN 110 is a GTP connection such as GTP-U (not illustrated in FIG. 2).

In one instance, the network provides a default QoS flow when establishing the PDU session 210. The UE 104 may use the default QoS flow to establish other QoS flows to support data traffic with more stringent QoS requirements, such as video streaming or real-time applications.

The UE 104 or the network can create additional dedicated QoS flows with QoS characteristics different from those of the default QoS flow. The UE may initiate the creation of the additional dedicated QoS flows by sending a request to the network. The network may initiate the creation of additional dedicated QoS flows using a policy control function (PCF).

The network configures the UE 104, the BS 108, and the CN 110 with the QoS requirements of the data flow. A successful configuration of the UE 104, the BS 108, and the CN 110 establishes a QoS flow, and the network assigns a QoS flow identification number (QFI). The QFI may represent the QoS characteristic of the QoS flow. Examples of QoS characteristics may be guaranteed bit rate (GBR) or non-guaranteed bit rate (Non-GBR) QoS flows. For example, QoS flow 1 can be a default QoS flow, QoS flow 2 a GBR QoS flow, and QoS flow 3 a Non-GBR QoS flow.

The BS 108 may map one or more QoS flows to an AS RB. For example, QoS flow 1 may be mapped to the radio bearer 1, and QoS flows 2 and 3 may be mapped to the radio bearer 2.

When SDFs share the same QoS characteristics and requirements, the transmitter may map one or more of those SDFs to the same QoS flow. For example, SDF 1 and SDF 2 are mapped to QoS flow 1, SDFs 3-4 are mapped to QoS flow 2, and SDFs 6 and 7 are mapped to QoS flow 3.

In some embodiments, the transmitter, e.g., the BS 108 or the UE 104, may allocate a number of BFs, for example, BFs 1-2, to serve an AS RB, e.g., AS RB 1 or BFs 3-5 to serve AS RB 2. The BFs 1-5 are air interfaces that provide more granular control and flexibility compared to AS RBs 1-2. The BFs may provide more control to provide fair service across different data traffic mapped to the same AS RB without impacting the end-to-end QoS flow handling. Examples of different data traffic may be data traffic within an AS RB carrying multiple QoS flows, QoS flows carrying multiple SDFs, or even different packet types within the same SDF, e.g., control packets such as TCP ACK versus normal IP (internet protocol) packets. The maximum number of BFs per AS RB may be defined per 3GPP TSs or dynamically configured by the network. The maximum number of BFs across all AS RBs may be defined by 3GPP TSs or configured by the network. In one instance, a BF may also be assigned to an SRB. In one example, only one BF may be assigned to an SRB. In another example, more than one BF may be assigned to an SRB.

A BF may be assigned to an AS RB when there is data traffic and can be released when, for example, there is no more data traffic. For example, BF 1 and 2 are assigned to AS RB 1, and BF 3-5 are assigned to AS RB 2. Each BF has its own L2 resource set to serve the traffic mapped to it, e.g., L2 layers sequence number, state variables, and timers. When a BF is assigned to an AS RB, the L2 resources set of the BF may be initialized to the L2 configuration of the AS RB to which the BF is assigned. The L2 configuration of the AS RB that the BF inherits may include sequence number (SN) size and radio link control (RLC) type. The end-to-end QoS, e.g., guaranteed bitrate or guaranteed latency, may apply for the whole set of BFs assigned to serve an AS RB. For example, logical channel prioritization applies on the AS RB level. The decision to assign a BF to an AS RB may be defined by 3GPP TS standards or left for implementation.

The transmitter may select a BF to serve data and assign the BF to an AS RB. For example, when the UE 104 starts an SDF, the UE 104 may select a BF to serve the SDF and assign the BF to an existing AS RB. For example, the SDF 6 is mapped to QoS flow 3, and QoS 3 is mapped to radio bearer 2 based on the network configuration. In one instance, when the UE 104 starts the SDF 6, the UE 104 may select BF 3 for SDF 6 and assign BF 3 to the radio bearer 2. In another instance, when the BS 108 receives a new SDF to be transmitted to the UE 104, the BS 108 may select a BF to serve the SDF and assign the BF to the AS RB. For example, the BS 108 may receive the SDF 6 from the data network (DN) with the UE 104 as its destination. The BS 108 may select BF 5 for SDF 6 and assign BF 5 to the radio bearer 2, which is not explicitly shown in the figure.

One or more BFs may be assigned to an AS RB. For example, bearer flows 3-5, which serve SDFs 3-7, may be assigned to AS RB 2. Whether an AS RB could be served by more than one BF could be configurable via network configuration such as radio resource control (RRC) configuration. When an AS RB is configured to have more than one bearer flow, in addition to RB identification (ID), the transmitter may indicate to the receiver the BF on which packets are mapped. In some instances, the network may selectively enable the use of bearer flows for a specific AS RB.

The assignment of a BF to an AS RB may be dynamic and based on a need. For example, when SDF 2 (mapped to AS RB 1) starts at the UE 104, the UE 104 determines that the SDF 2 would benefit from being served by a BF that is different from the BF that serves SDF 1. The UE 104 may then assign the bearer flow 2 to the radio bearer 1 and map the SDF 2 to the BF 2. In another example, when SDF 6 (mapped to AS RB 2) starts at the UE 104, the UE 104 determines that the SDF 6 does not require a new bearer flow and can be served by the bearer flow 3, along with SDF 3. Once the entity that initially assigned the BF to the AS RB does not need the BF, it may release the BF. This may allow the BF to be assigned to other RBs. Dynamically assigning L2 resources across AS RBs based on need and load on the AS RBs may serve the data traffic more efficiently or fairly. In some instances, the RRC connection only configures a subset of all AS RBs; therefore, some L2 resources remain unused. Different data can be served better by allocating unused L2 resources to bearer flows.

In some embodiments, each configured AS RB with active data traffic may have at least one BF, e.g., a default BF, assigned to it. The default BF serves all the traffic by default until the transmitter determines that an additional BF is needed. For example, bearer flow 1 assigned to AS RB 1 and bearer flow 3 assigned to AS RB 2 may be default bearer flows. A bearer flow may serve only one AS RB.

Based on local information or conditions, the UE 104 or the BS 108 may freely select an existing BF assigned to the AS RB or assign a new bearer flow to the AS RB to serve data traffic mapped to the same AS RB. Examples of local information may be the number of current active SDFs or applications having data to be served, application metadata, link quality, block error rate, congestion metrics, or queue size. Mapping of SDFs or data traffic to a BF may dynamically change when the local information or condition changes. For example, during an RRC connection, a BF may be re-assigned to serve a different AS RB or a different SDF within the same AS RB.

In some embodiments, the UE 104 and the BS 108 may be aligned on the usage of a BF in both the uplink (UL), e.g., data traffic from the UE 104 towards the DN, and the downlink (DL), e.g., data traffic from the DN towards the UE 104, directions. The UE 104 and the BS 108 may be aligned on the UL and DL directions based on the data traffic properties. For example, an SDF requiring guaranteed serving quality, such as real-time application data, may require alignment between UL and DL transmissions.

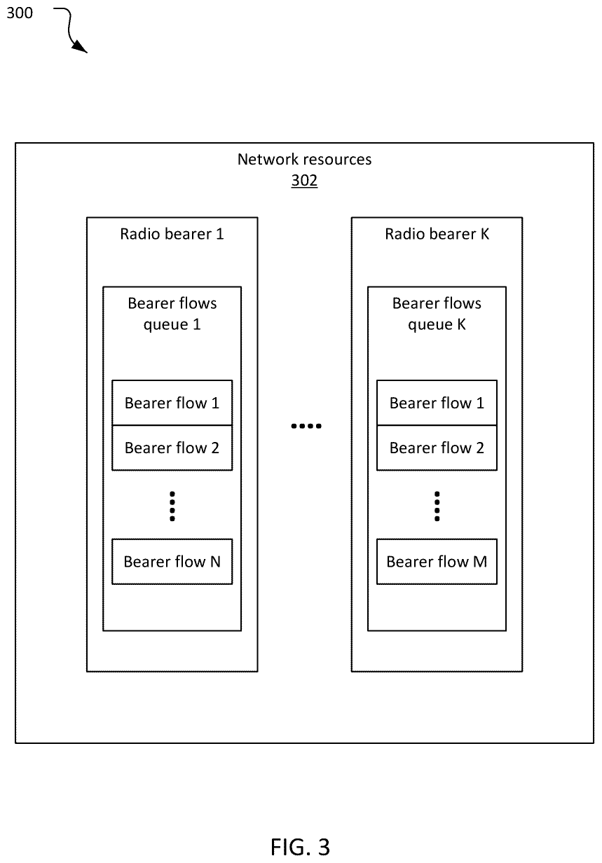

FIG. 3 illustrates a radio bearer flow configuration 300 in accordance with some embodiments. The bearer flow configuration 300 allocates the network resources 302 among the K configured AS RBs, for example, AS RBs 1-K. When configuring an AS RB, the network, e.g., the base station, may configure a bearer flows queue associated with the AS RB, e.g., bearer flows queue 1 for radio bearer 1, and bearer flows queue K for radio bearer K. Bearer flows queue manages the assignment of bearer flows to data traffics. As discussed above, a bearer flow may be assigned to an AS RB by the UE or the BS.

In one instance, when the radio bearer 1 is configured, the network allocates N bearer flows, e.g., bearer flows 1-N, to be used by the radio bearer 1. In another instance, when the radio bearer K is configured, the network allocates M bearer flows, e.g., bearer flows 1-M, to be used by the radio bearer K.

In one instance, the network configures the maximum number of bearer flows that can be assigned to a radio bearer. The maximum number of the bearer flows may be statically or dynamically configured. In some embodiments, the maximum number of bearer flows for an AS RB in a static configuration does not change. However, in a dynamic configuration, the maximum number of bearer flows for an AS RB may change. All configured radio bearers may have an equal number of allocated bearer flows. The 3GPP TS standard may limit the number of bearer flows allocated to AS RBs serving data traffic of a given UE, e.g., the UE 104.

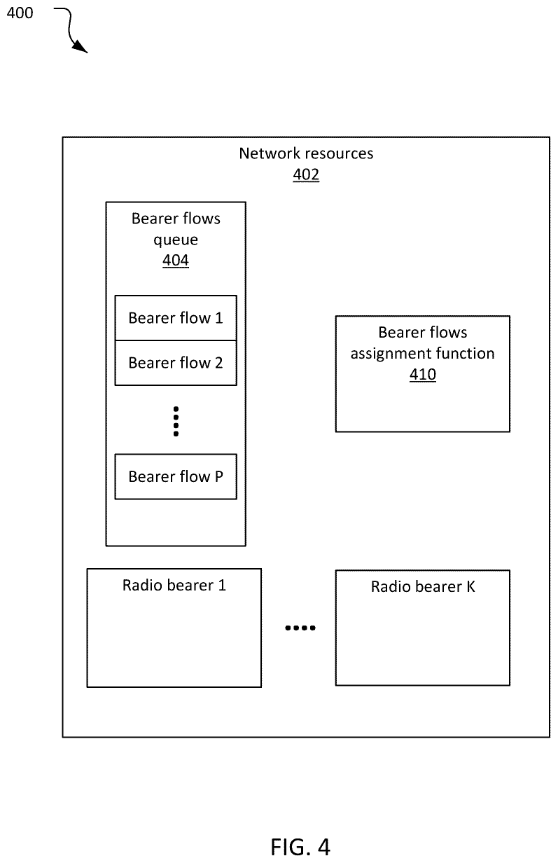

FIG. 4 illustrates a radio bearer flow configuration 400 in accordance with some embodiments. The bearer flow configuration 300 allocates the network resources 402 among the K configured AS RBs, e.g., radio bearers 1-K. When a UE, e.g., the UE 104, is powered on and successfully connects to a network and establishes an RRC connection, the network, e.g., the base station 108, may allocate a set of bearer flows to the UE, e.g., bearer flows 1-P. As discussed above, a bearer flow may be assigned to an AS RB by the UE or the BS. The BS may configure the maximum number of bearer flows, P, or it may be capped or fixed by the 3GPP TSs. When the 3GPP TSs limit the maximum number of bearer flows, the BS cannot configure a number of bearer flows larger than that limit.

Based on local information, the UE or the BS may determine that the data traffic assigned to an AS RB should be mapped to a bearer flow. Consider, for example, that the bearer flow is a new flow without active traffic. In that case, the bearer flows assignment function 410 may select an available bearer flow from the bearer flows queue 404, assign the bearer flow to the AS RB, initialize the bearer flow, and map the data traffic to the selected bearer flow. In another example, the bearer flow may be a configured bearer flow assigned to the same AS RB as the data traffic. In that case, the bearer flows assignment function 410 maps the data traffic to the bearer flow. All configured AS RBs may share a common pool of bearer flows. The bearer flows queue 404 is a logical queue that keeps the status of the bearer flows.

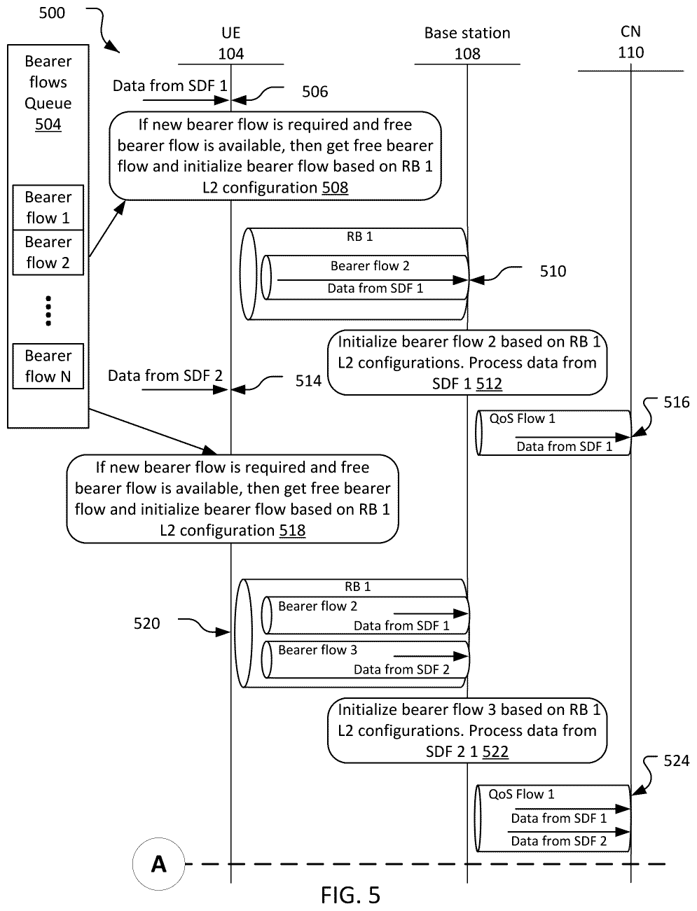

FIG. 5 illustrates a signaling diagram 500 in accordance with some embodiments. The signaling diagram 500 is an example of signals and procedures involved in serving data traffic on bearer flows. In diagram 500, the UE 104 initiates the data traffic and assigns the bearer flow. A similar signaling and procedure may apply when the BS 108 or the CN 110 initiates data traffic to be sent to the UE 104. The UE 104 is configured with RB 1, and QoS flow 1 is mapped to RB 1. For example, QoS flow 1 may be the default internet bearer.

At 506, the UE 104 receives uplink data traffic from SDF 1 assigned to RB 1. The SDF 1 may include, for example, data for a video call initiated by a social media application. The UE 104 determines whether SDF 1 requires a new bearer flow. The UE 104 may consider whether a free bearer flow is available in the bearer flows queue 504. If a free bearer flow is unavailable, the UE 104 may map SDF 1 to an existing bearer flow with active data traffic.

At 508, if the UE 104 determines that a free bearer flow is available, the UE 104 gets the bearer flow, e.g., bearer flow 2, from the bearer flows queue 504, initializes it based on RB 1 L2 configuration, and maps the SDF 1 to bearer flow 2. Bearer flow 2 has its own L2 resource set and inherits the RB 1 L2 configuration, e.g., SN sizes and RLC entities types.

In one instance, the bearer flows queue 504 is a logical queue that holds the unassigned bearer flows. Once a bearer flow is assigned to an AS RB, it is taken out of the queue 504. The bearer flow is returned and added to the queue 504 once the bearer flow is released. The UE 104 also may map the SDF 1 traffic to QoS flow 1 based on the QoS requirements of the SDF 1.

At 510, the bearer flow 2 serves SDF 1, and the BS 108 receives the data from SDF 1. Packet delivery to the upper layer of SDF 1 packets on bearer flow 2 may not depend on packets from any SDFs served by other BFs. Without bearer flows, data packets of SDF 1 could be blocked from being delivered to upper layers due to missing packets from other SDFs assigned to the same AS RB.

At 512, based on the received packet, the BS 108 learns about the mapping of SDF 1 to bearer flow 2, initializes bearer flow 2 based on RB 1 L2 configurations, and processes the data from SDF 1.

At 514, the UE 104 receives data from SDF 2 mapped to RB 1. The SDF 2 may include, for example, data traffic associated with file downloading. The UE 104 may map the SDF 2 to QoS flow 1 based on the network configuration. The network may control the mapping of SDFs to QoS flows. The network may control the mapping of QoS flows to AS RBs. In another example, SDF 2 may be replaced by SDF 1, where the UE 104 decides to serve different packet types in SDF 1 on different bearer flows.

At 516, the CN 110 receives data from SDF 1 mapped to QoS flow 1. The transport of data from SDF 1 on QoS flow 1 to the CN 110 may be independent of the mapping of SDF 1 to bearer flow 2.

The UE 104 at 518 may determine that the SDF 2 traffic should be mapped to a new bearer flow. The UE 104 may determine that a free bearer flow is available. The UE 104 may get the bearer flow, e.g., bearer flow 3, from the bearer flows queue 504, initialize it based on RB 1 L2 configuration, and map the SDF 2 to bearer flow 3. Bearer flow 3 has its own L2 resource set, independent from the L2 resource set of SDF 1, and may inherit the RB 1 L2 configuration, e.g., SN sizes and RLC entities types.

At 520, the UE 104 may process the data from SDF 1 and SDF 2 and transmit the data from SDF 1 on bearer flow 2 and data from SDF 2 on bearer flow 3 to the BS 108. The UE 104 processes the transmission and retransmission of data from SDF 1 independent of the transmission and retransmission of data from SDF 2 because SDF 1 and SDF 2 are mapped to different bearer flows.

Without utilizing bearer flows, when SDF 1 and SDF 2 are transported on AS RB, packets of both SDF 1 and SDF 2 are associated with the sequence numbers (SNs) of AS RB. The SDF 1 data packet transmission could be delayed due to the retransmission(s) of SDF 2 old packets or due to transmission(s) of new SDF2 packets received before SDF 1 packets.

By mapping SDF 1 to bearer flow 2 and SDF 2 to bearer flow 3, SDF 1 packets would be served by bearer flow 2 and its dedicated L2 resource set and SDF 2 packets would be served by bearer flow 3 and its dedicated L2 resource set. Transmission of SDF 1 packets would be independent of SDF 2 packets transmission. By mapping SDFs to different independent bearer flows, the transmitter has more control over the order, latency, and jitter of the different SDFs carried within the AS RB.

In some embodiments, the UE 104 may prioritize serving the data traffic of one SDF over another. In the first alternative, the priorities associated with each SDF may be static and may be defined in the 3GPP TSs. For example, the priority of a bearer flow may be related to the bearer ID value. For example, if the ID of bearer flow 2 is a and the ID of bearer flow 3 is b, then bearer flow 2 has a higher priority over bearer flow 3 if a is larger than b. In another example, bearer flow 2 has a higher priority over bearer flow 3 if a is smaller than b. In another example of a statically configured priority, all bearer flows may have the same priorities and may be served in a round-robin manner.

In a second alternative, the priorities may not be configured and may not be aligned between the transmitter and the receiver. The transmitter may decide which flow to serve. The uplink and downlink flow may not only be mapped to different bearer flows but also may have different priorities.

At 522, based on the received packets, the BS 108 may learn about the mapping of SDF 2 to bearer flow 3, initialize bearer flow 2 based on RB 1 L2 configurations, and process the data from SDF 2. The BS 108 processes the data received on bearer flow 2 independent from the data received on bearer flow 3.

At 524, the BS 108 may multiplex packets received from RB 1 on different bearer flows into one stream and send them to the CN 110. The CN 110 receives data from SDF 1 and SDF 2, mapped to QoS flow 1. The transport of data from SDF 1 and SDF 2 on QoS flow 1 to the CN 110 may be independent of the mapping of SDF 1 to bearer flow 2 and SDF 2 to bearer flow 3.

The network configures AS RBs and maps QoS flows to AS RBs based on the QoS characteristics of AS RBs. The transmitter, the UE 104 in the UL or the BS 108 in the DL, maps an SDF to an AS RB based on the network configuration. The bearer flow provides a flexible method for separating the data traffic assigned to an AS RB and serving the separate data independently from each other without any negative impact on the underlying QoS characteristics of the QoS flows. Bearer flows may be transparent to non-access stratum (NAS) QoS key performance indicators (KPIs) and may not impact the QoS system. Using bearer flows may not impact the logical channel assigned to an AS RB.

The link between AS RB and L2 resource sets assigned to bearer flows can be one-to-many. The multiple L2 resource sets linked to an AS RB provide flexibility in that different traffic mapped to the same AS RB could be served independently.

The data traffic served independently on different bearer flows may be data traffic from different SDFs or different packet types within the same SDF. The underlying QoS may remain unaffected by bearer flows inheriting the AS RB's L2 configuration, such as timer durations, sequence number sizes, and discard timer duration.

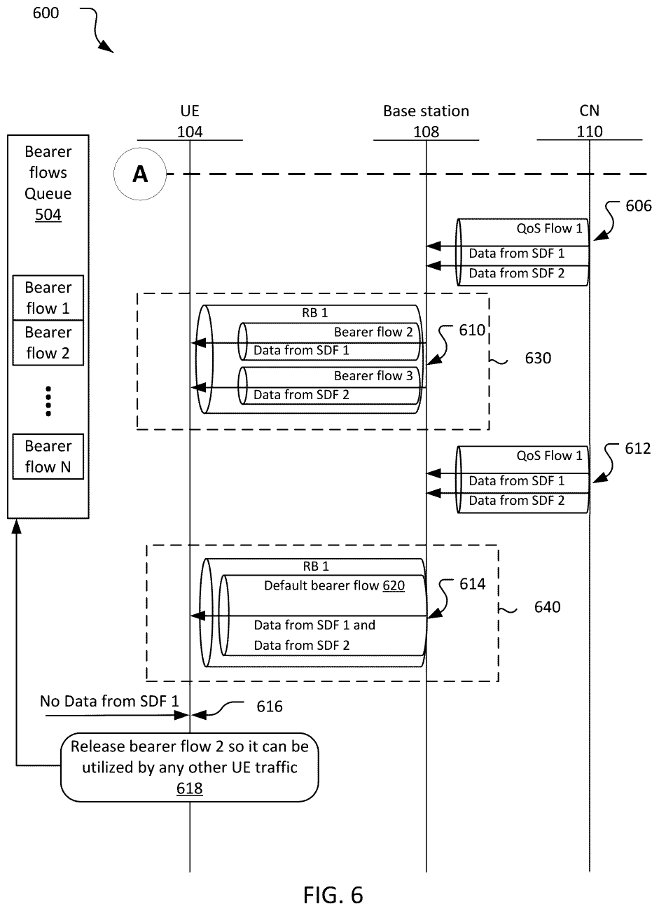

FIG. 6 is a continuation of FIG. 5. Reference point ‘A’ marks the common point in FIGS. 5 and 6.

FIG. 6 illustrates a signaling diagram 600 in accordance with some embodiments. Signaling diagram 600 is a continuation of signaling diagram 500, with the reference point ‘A’ marking the common point in the two signaling diagrams. As illustrated, FIG. 5 describes an example of the UL traffic flow, and FIG. 6 illustrates an example of the DL traffic flow. Signaling diagram 600 includes two methods of serving the downlink data: mapping 630 and mapping 640.

The BS 108 may use the mapping 630 in which SDF 1 and SDF 2 are mapped to two separate BFs. The BS 108 maps the SDF 1 to BF2 and the SDF 2 to BF 3.

In one instance, the mapping of traffic flows to BFs at the DL flow may be aligned with the mapping of the traffics to BFs at the UL flow. The transmitters on UL and DL (the UE 104 is the UL transmitter, and the BS 108 is the DL transmitter) are aligned when they share a common configuration for serving an SDF. For example, the transmitters are configured to serve SDF 1 using a separate BF from all other active traffics. The UL and DL may map SDF 1 to the same BF or to different BFs. The network signaling may align the transmitters for a given SDF, e.g., whether the SDF should be mapped to the same BF on UL and DL.

In one instance, the mapping of a traffic flow to a BF is not aligned in the UL and DL. The transmitters map the SDF independently of one another to a BF. In one example implementation of non-aligned mapping, the UE 104 may follow the BS 108 mapping without any mandate, requirement, or common configuration. The mapping of SDF 1 to BF 2 at 610 may or may not be aligned with the mapping of SDF 1 to BF2 at 508 in FIG. 5. Similarly, the mapping of SDF 2 to BF 3 at 610 may or may not be aligned with the mapping of SDF 2 to BF 3 at 518 in FIG. 5. The network configuration and whether the UE 104 and the BS 108 coordinate with one another in mapping a traffic flow to a BF may determine whether the mapping is aligned or non-aligned.

There are different options for implementing aligned mapping 630. In the first option, L2 signaling aligns the mapping of an SDF to a bearer flow between the UE 104 and the BS 108. In the second option, the RRC signaling aligns the mapping of an SDF to a bearer flow between the UE 104 and the BS 108. In the third option, the MAC control elements align an SDF mapping to a bearer flow between the UE 104 and the BS 108.

The BS 108 may use the mapping 640 in which SDF 1 and SDF 2 are mapped to the same BF. In one instance, the BS 108 maps the SDF 1 and SDF 2 to the default BF 620. The mapping of SDF 1 to the default BF 620 may or may not be aligned with the mapping of SDF 1 to BF 2 (for example, at 508 in FIG. 5). Similarly, the mapping of SDF 2 to the default BF 620 may or may not be aligned with the mapping of SDF 2 to BF3 (for example, at 518 in FIG. 5).

The UE 104 and the BS 108 may adopt a combination of non-aligned and aligned mappings. For example, the UE 104 and the BS 108 use aligned mapping on previously configured or predetermined bearer flows. The UE 104 and the BS 108 may use non-aligned mapping on other unspecified bearer flows.

As previously mentioned with respect to FIG. 5, the network has configured RB 1 as the radio bearer and mapped the QoS flow 1 to RB 1. SDFs 1 and 2 are assigned to RB 1 and mapped to QoS flow 1. SDF 1 is assigned to bearer flow 2, SDF 2 is assigned to bearer flow 3, and both the UE 104 and the BS 108 know all the above-mentioned configurations, assignments, and mappings.

At 606, the CN 110 receives DL data from SDF 1 and SDF 2, maps the data to QoS flow 1, and sends the data to the BS 108. The BS 108 receives the data from SDF 1 and 2. The BS 108 processes the data from SDF 1 independent of the data from SDF 2.

At 610, the BS 108 maps the data from SDF 1 to bearer flow 2 and the data from SDF 2 to bearer flow 3. The BS 108 maps the SDF to the same BF as the UE 104. The transmission and retransmission of data mapped to bearer flow 2 are independent of the transmission and retransmission of data mapped to bearer flow 3.

In another example, at 612, the CN 110 receives data from SDF 1 and SDF 2 on the downlink flow for the UE 104. The CN 110 maps the data from SDF 1 and SDF 2 to QoS flow 1 and sends them to the BS 108. The BS 108 may implement different priority schemes for serving bearer flow 2 and 3 as described above with respect to item 520 in FIG. 5.

At 614, the BS 108 receives the data from SDF 1 and SDF 2. The BS 108 does not follow the UL differentiation for the SDFs in the mapping of SDF 1 to bearer flow 2 and SDF 2 to bearer flow 3 for the DL transmission. The BS 108 may not be aligned with the UE 104 on mapping SDFs to bearer flows and may use a mapping different from the UE 104. The BS 108 maps the DL data flow of SDF 1 and SDF 2 to the same bearer flow, e.g., default bearer flow 620. Data processing, transmission, and retransmission from SDF 1 and SDF 2 depend on one another and are based on the L2 resource set of the default bearer 620.

At 616, the UE 104 receives an indication that the SDF 1 has no more data for transmission. If no other active data is assigned to bearer flow 2, at 618, the UE 104 may release bearer flow 2. Once released, the bearer flow 2 will be added to the bearer flows queue 504 and will be available to be assigned to an AS RB.

For example, when an application socket closes, the application does not generate data for transmission and may indicate to the UE 104 that the corresponding SDF has no more data. In another example, a bearer flow is not required anymore when the data transfer on the SDF mapped to that bearer flow is timed out. In one instance, the transmitter may not have any free BF available to it, and the transmitter requires a BF for serving high-priority SDF on an AS RB without any assigned BF or without any BF with required configurations. The transmitter may release a BF that is currently serving one or more SDFs and map the high-priority SDF to it.

In one instance, the release of a bearer flow may be implicitly or explicitly aligned between the UE 104 and the BS 108. For example, the implicitly aligned release may occur when a BF assignment to an AS RB is removed, and the BF is assigned to another AS RB. Explicitly aligned release may occur when a control message from the transmitter to the receiver indicates that the BF is released from the assigned AS RB.

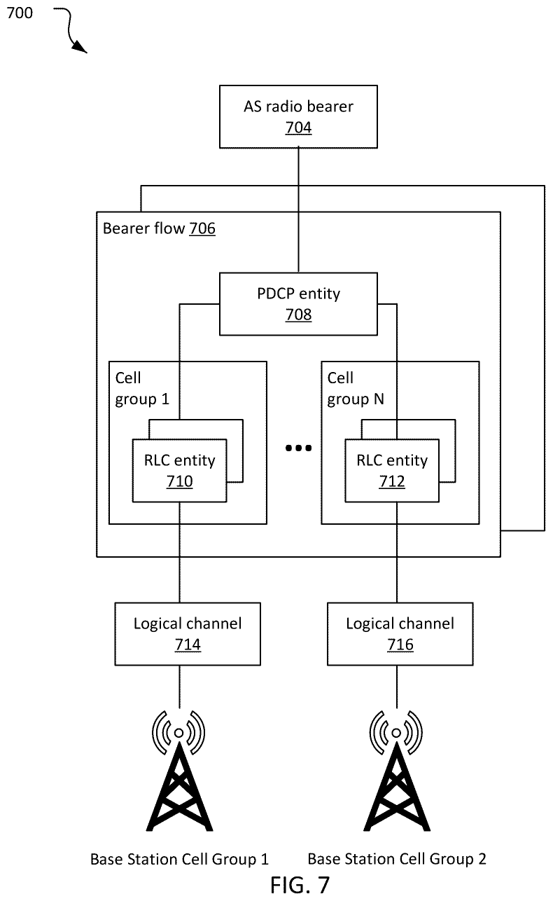

FIG. 7 illustrates a radio bearer structure 700 in accordance with some embodiments. AS RB 704 is associated with one or more bearer flows, e.g., the bearer flow 706. Each bearer flow associated with the AS RB 704 may have a similar structure as the bearer flow 706. The bearer flow 706 may include a PDCP entity 708. For example, the hyper frame number of the PDCP entity 708 is maintained per bearer flow.

The PDCP entity 708 may be associated with one, two, or four RLC entities 710-712. The association may be based on RB characteristics (e.g., unidirectional or bidirectional) or RLC mode. For example, for cell group 1, the RLC entity 710 may be associated with logical channel 714. Similarly, in cell group N, the RLC entity 712 may be associated with logical channel 716.

In one instance, when a bearer flow is assigned to an AS RB, all variables, constants, and timers of the entities associated with the bearer flow are reinitialized based on the AS RB configuration. In some instances, the value of HFN is retained and remains unaffected by reinitialization of the BF, and the network should ensure that the same COUNT parameter, which is computed based on the PDCP HFN and SN (sequence number), is not re-used with a given key. In addition, initialization, releasing, or unmapping of a BF may not affect HFN and may not lead to HFN initialization.

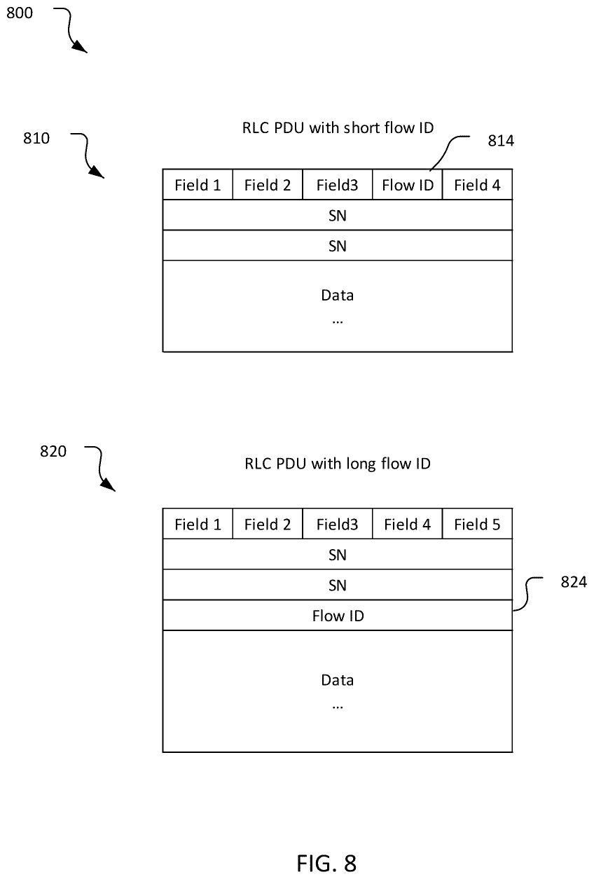

FIG. 8 illustrates a packet header 800 in accordance with some embodiments. Each data packet may include a bearer flow ID to allow the receiver to distinguish between packets served by different bearer flows. In one instance, the RLC header of the data packet may include the bearer flow ID. In another instance, the MAC sub-header may include the bearer flow ID.

The RLC PDU 810 includes a header and data payload. The header includes short fields, e.g., Fields 1-4. One of the short fields may be allocated for Flow ID 814. The RLC packet may also include long fields for sequence numbers and data.

The RLC PDU 820 includes a header and data payload. The header includes short fields, e.g., Fields 1-5. The header includes long fields, such as two long fields allocated for sequence numbers (SNs). For example, one long field may be allocated to bearer flow ID 824.

The MAC sub-header may contain the bearer flow ID (not depicted). For example, the logical channel ID (LCID) field in the MAC sub-header may indicate both the logical channel's identity and the bearer flow ID. The LCID may also represent the RB ID.

In one instance, the MAC layer LCID of the AS RB is associated with one or more BFs, where the BFs are mapped to the AS RB. In addition, each BF mapped to the AS RB has its own dedicated L2 layer resource set.

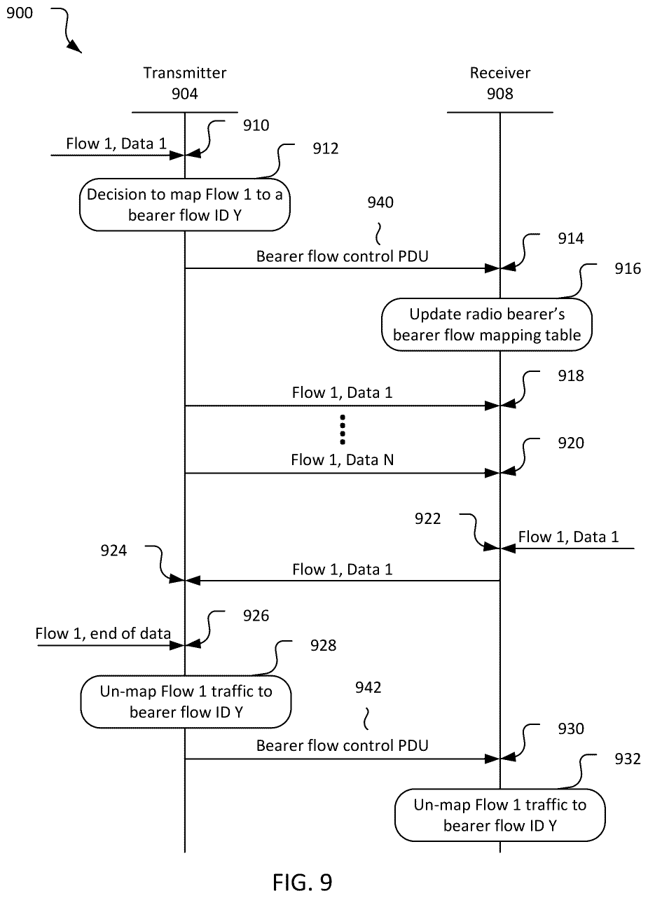

FIG. 9 illustrates a signaling diagram 900 in accordance with some embodiments. The signaling diagram 900 is an example of using L2 signaling to align the mapping of the UL flow and DL flow of an SDF to the same bearer flow. The transmitter 904 may be the UE, e.g., the UE 104 in FIG. 1, or the BS, e.g., the BS 108 in FIG. 1. The receiver 908 may be the UE, e.g., the UE 104 in FIG. 1, or the BS, e.g., the BS 108 in FIG. 1.

At 910, the transmitter 904 receives data 1 of traffic flow 1 mapped to AS RB 1. The traffic flow 1 is not mapped to any bearer flow yet, or the traffic flow 1 is mapped to a bearer flow, but the local condition and information are changed, and the transmitter 904 decides to change the bearer flow associated with the flow 1.

At 912, the transmitter 904 decides to map flow 1 to a bearer flow Y (bearer flow ID value is symbolically represented by ‘Y’).

At 914, the transmitter 904 sends an RLC bearer flow control PDU 940, and the receiver 908 receives the bearer flow control PDU 940. The RLC bearer flow control PDU 940 may be used for aligning the mapping of the flow 1 to bearer flow Y between the transmitter 904 and the receiver 908.

The RLC bearer flow control PDU 940 may include a bearer flow ID to indicate the bearer flow to which the traffic flow 1 should be mapped. Control PDU 940 may include a mapping-start indicator. A value ‘1’ or logical value ‘True’ may indicate the mapping of the SDF to the bearer flow identified by the bearer flow ID is to be started. Control PDU 940 may include a mapping-stop indicator. A value ‘1’ or logical value ‘True’ may indicate the mapping of the SDF to the bearer flow identified by the bearer flow ID is ended. The mapping-stop may only end the mapping. The traffic flow 1 may be mapped to another bearer flow or be served on the default bearer flow. Ending a traffic flow mapping may not end the bearer flow. For example, other traffic flows may be mapped to the bearer flow. The control PDU 940 may include the AS traffic template ID and AS traffic template. The AS traffic template may map traffic flow 1 to bearer flow Y. The control PDU 940 transmitted at 914 has enabled the mapping-start field, set to value ‘1’ or ‘True.’

At 916, the receiver 908 updates AS RB bearer flow mapping table to indicate the mapping of traffic flow 1 to bearer flow Y. The bearer flow mapping table stores the association between a traffic flow and a bearer flow. For example, the bearer flow mapping table may store the traffic flow ID and associate it with the bearer flow ID.

At 918 to 920, the transmitter 904 sends the UL data 1-N of traffic flow 1, and receiver 908 receives the data 1-N of traffic flow 1. Data packets 1-N include the bearer flow ID of the bearer flow Y to allow the receiver 908 to identify the bearer flow. At 922, receiver 908 receives DL data 1 of traffic flow 1. The traffic mapping is aligned. Therefore, the receiver 908 maps the DL traffic flow to bearer Y. At 924, the receiver 908 sends, and the transmitter 904 receives the DL data 1 of traffic flow 1. The DL data packet 1 includes the bearer flow ID of the bearer flow Y to allow the transmitter 904 to identify the bearer flow.

At 926, the transmitter 904 receives an unmapping indication. The unmapping indication may be based on the termination of the traffic flow. For example, the source or application for traffic flow 1 is closed. In response to the unmapping indication, at 928, the transmitter 904 removes the mapping of the traffic flow 1 from the bearer flow Y.

A BF may transport the data traffic of several SDFs/traffic flows. When an SDF or a traffic flow does not have any additional data, that SDF or traffic flow is removed or unmapped from the BF. To remove the association between the BF and AS RB, the UE or the BS, need to detect and determine conditions for releasing the BF. For example, one condition may be when there is no active data, SDF, or traffic flow mapped to the BF, the BF can be released, and its association with the AS RB may be removed. Another condition may be when no BF is available that is not assigned to an AS RB, and an important SDF is required to be served using a BF that is not shared with other active data traffic. In this condition, the transmitter or the network may re-map the traffic of a BF with active traffic and release the BF so the important SDF can be mapped to it. In another example, a BF associated with an AS RB is released when the AS RB is released. At 930, the transmitter 904 sends, and the receiver 908 receives the bearer flow control PDU 942. The control PDU 942 has enabled the mapping-stop field, set to value ‘1’ or ‘True.’

At 932, the receiver 908 may un-map flow 1 traffic from the bearer flow Y and update the AS RB bearer flow mapping table.

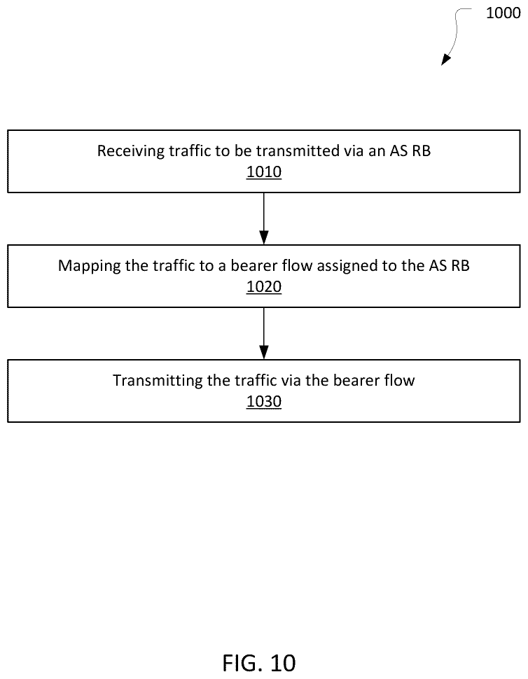

FIG. 10 illustrates an operational flow/algorithmic structure 1000 in accordance with some embodiments. In some embodiments, the operational flow/algorithmic structure 1000 may be performed by a transmitter.

At 1010, the operational flow/algorithmic structure 1000 includes receiving a traffic flow to be transmitted via an AS RB. The traffic flow may be associated with the AS RB via a traffic flow template (TFT) or some other way.

At 1020, the operational flow/algorithmic structure 1000 includes mapping traffic to a bearer flow assigned to the AS RB. The traffic may be mapped to the bearer flow based on local conditions detected by the transmitter.

In some embodiments, the transmitter may assign the bearer flow to the AS RB. This may be based on the traffic flow received at 1010. When the bearer flow is assigned to the AS RB, an L2 resource set may be assigned to the bearer flow, and the bearer flow may be initialized with the L2 configuration of the AS RB.

At 1030, the operational flow/algorithmic structure 1000 includes transmitting the traffic via the bearer flow. The transmitter may include a flow identification number in the packet header associated with the Access Stratum. The transmitter may receive data from other flows assigned to the same AS RB and mapped to a different bearer flow. The transmitter may process the data flows assigned to different bearer flows independently, and the transmission and retransmission of packets of one data flow may not impact the transmission and retransmission of packets of another data flow.

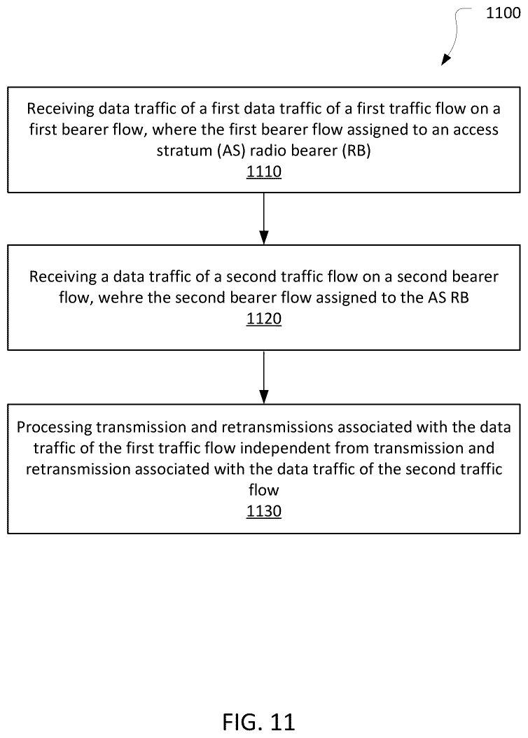

FIG. 11 illustrates an operational flow/algorithmic structure 1100 in accordance with some embodiments. In some embodiments, the operational flow/algorithmic structure 1100 may be performed by a receiver.

At 1110, a first device receives data traffic of a first traffic flow from a second device. The first device may be a base station, e.g., the BS 108 in previous figures. The second device may be a UE, e.g., the UE 104 in previous figures. The data traffic may be the UL transmission from the UE, and the traffic flow may be an SDF carrying application data to and from the UE. The first device receives the data traffic on a first bearer flow where the first bearer flow is assigned to an AS RB.

The first device detects a flow identifier in the packet header associated with the first traffic flow. Based on the flow identifier, the first device determines the association between the data traffic of the first traffic flow and the first bearer flow. The first device may have a logical mapping table to store traffic and bearer flows' association. The first device may update the mapping table with the association of the first traffic flow to the first bearer flow.

The first device may also determine the QoS of the AS RB. For example, the first device may determine the QoS of the AS RB from the L2 parameters and configuration of the AS RB. The first device may associate the QoS of the AS RB with the first bearer flow based on the association of the first bearer flow with the AS RB.

At 1120, the first device receives another data traffic of a second traffic flow. The second traffic flow may be another SDF carrying another application data or the same SDF carrying different data packets, e.g., packets with different QoS requirements or priorities. The first device receives the data traffic of the second traffic flow on a second bearer flow, where the second bearer flow is also assigned to the same AS RB as the first bearer flow.

The data traffic of the first traffic flow may be the UL traffic sent by the UE on the first bearer and received by the BS. The BS may also receive the DL traffic of the first traffic flow sent by the CN and received by the BS. The first device, e.g., the BS, may send the DL traffic to the UE using the first bearer flow or another bearer flow.

At 1130, the first device processes transmission and retransmissions associated with the data traffic of the first traffic flow independently from the transmission and retransmission associated with the data traffic of the second traffic flow.

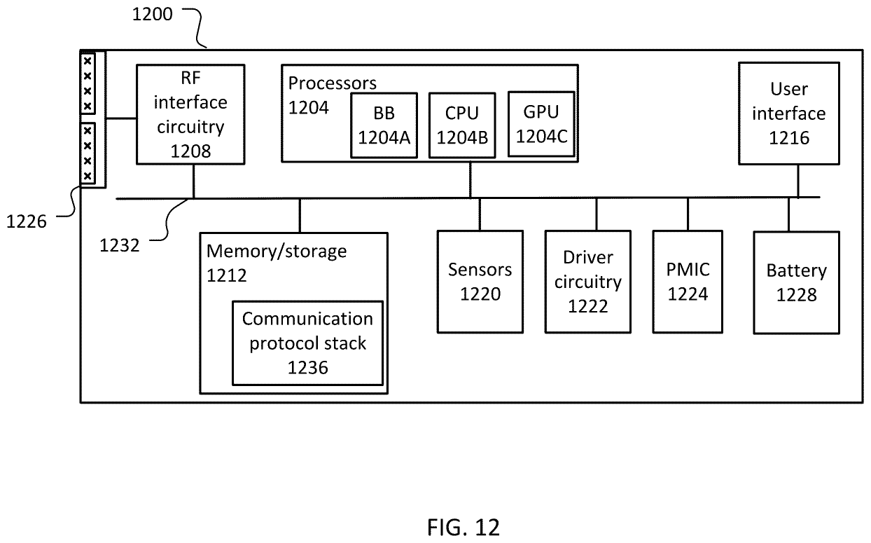

FIG. 12 illustrates a UE 1200 in accordance with some embodiments. The UE 1200 may be similar to and substantially interchangeable with UE 104 of FIG. 1.

The UE 1200 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry, or processor circuitry that executes or otherwise operates computer-executable instructions, such as program code, software modules, or functional processes from memory/storage 1212 to cause the UE 1200 to perform operations as described herein.

The processors 1204 may perform operations associated with bearer flows as described elsewhere herein. For example, the processors 1204 may assign bearer flows to AS RBs, map traffic flows to the bearer flows, and generate packet headers to provide an indication of the mapped bearer flows consistent with the embodiments described herein.

In some embodiments, the baseband processor circuitry 1204A may access a communication protocol stack 1236 in the memory/storage 1212 to communicate over a 3GPP-compatible network. In general, the baseband processor circuitry 1204A may access the communication protocol stack 1236 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on the cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, the communication protocol stack 1236) that may be executed by one or more of the processors 1204 to cause the UE 1200 to perform various operations described herein. The memory/storage 1212 includes any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processor 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands, including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various I/O devices that may be present within or connected to the UE 1200. For example, the driver circuitry 1222 may include circuitry to facilitate the coupling of a universal integrated circuit card (UICC) or a universal subscriber identity module (USIM) to the UE 1200. For additional examples, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage the power provided to various components of the UE 1200. In particular, with respect to the processors 1204, the PMIC 1224 may control power-source selection, voltage scaling, battery charging, or DC-to-DC conversion.

In some embodiments, the PMIC 1224 may control or otherwise be part of various power-saving mechanisms of the UE 1200, including DRX, as discussed herein.

A battery 1228 may power the UE 1200, although in some examples, the UE 1200 may be mounted and deployed in a fixed location and may have a power supply coupled to an electrical grid. The battery 1228 may be a lithium-ion battery, a metal-air battery, such as a zinc-air battery, an aluminum-air battery, a lithium-air battery, and the like. In some implementations, such as in vehicle-based applications, the battery 1228 may be a typical lead-acid automotive battery.

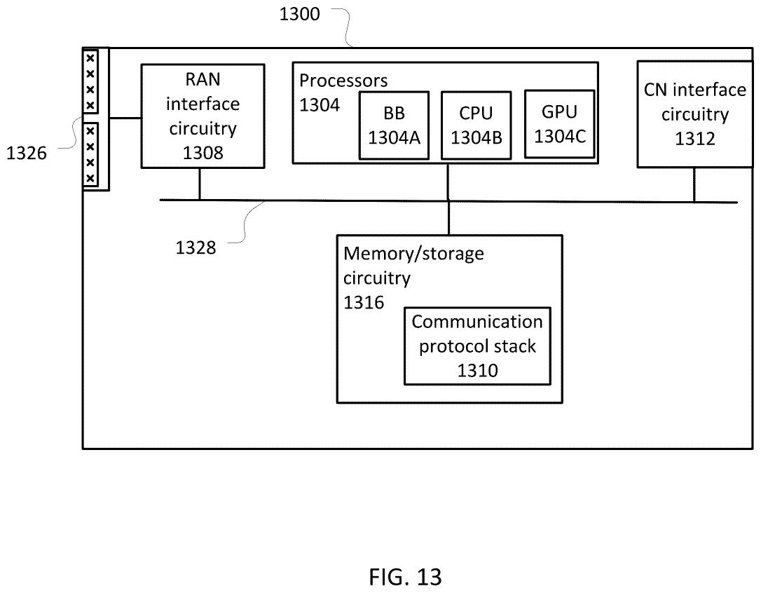

FIG. 13 illustrates a network node 1300 in accordance with some embodiments. The network node 1300 may be similar to and substantially interchangeable with base station 108, a device implementing one of the network hops, an integrated access and backhaul (IAB) node, a network-controlled repeater, or a server in a core network or external data network.

The network node 1300 may include processors 1304, RF interface circuitry 1308 (if implemented as an access node), the core node (CN) interface circuitry 1312, memory/storage circuitry 1316, and antenna structure 1326.

The components of the network node 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The processors 1304 may perform operations associated with bearer flows as described elsewhere herein. For example, the processors 1304 may receive another data traffic of the same or different traffic flow mapped to another bearer flow and process the transmission and retransmission associated with the data traffics mapped to different bearer flows independent of one another.

The CN interface circuitry 1312 may provide connectivity to a core network, for example, a 5th Generation Core network (5GC) using a 5GC-compatible network interface protocol such as carrier Ethernet protocols or some other suitable protocol. Network connectivity may be provided to/from the network node 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

In some embodiments, the network node 1300 may be coupled with transmit-receive points (TRPs) using the antenna structure 1326, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method of serving data traffic in a cellular communication system, the method including: receiving traffic to be transmitted via an access stratum (AS) radio bearer (RB); mapping the traffic to a bearer flow assigned to the AS RB; and transmitting the traffic via the bearer flow.

Example 2 includes the method of example 1 or some other examples herein, and further including: assigning the bearer flow to the AS RB; and initializing, based on said assigning of the bearer flow to the AS RB, a layer 2 (L2) resource set associated with the bearer flow based on a configuration of the AS RB.

Example 3 includes the method of examples 1 or 2 or some other examples herein, wherein the L2 resource set includes sequence numbers, state variables, or timers.

Example 4 includes the method of any of examples 1-3 or some other examples herein, wherein the traffic is a first service data flow (SDF), the bearer flow is a first bearer flow, and the method further includes: receiving a second SDF; assigning a second bearer flow to the AS RB; mapping the second SDF to the second bearer flow; and transmitting the second SDF via the second bearer flow, wherein the first bearer flow is associated with a first layer 2 (L2) resource set and the second bearer flow is associated with a second L2 resource set.

Example 5 includes the method of any of examples 1-4 or some other examples herein, wherein serving the first bearer flow and the second bearer flow is based on configured priorities of the first bearer flow and the second bearer flow or is based on a round-robin method.

Example 6 includes the method of any of examples 1-5 or some other examples herein, wherein transmissions and retransmissions associated with transmitting the first SDF are independent from transmissions and retransmissions associated with the second SDF.

Example 7 includes the method of any of examples 1-6 or some other examples herein, wherein: the first bearer flow is associated with a first packet data convergence protocol (PDCP) entity and the first PDCP entity includes a first hyper frame number (HFN); the second bearer flow is associated with a second PDCP entity and the second PDCP entity includes a second HFN; and the method further includes: maintaining the first HFN independent from the second HFN, maintaining the first HFN at initializing, releasing, or unmapping of the first bearer flow, and maintaining the second HFN at initializing, releasing, or unmapping of the second bearer flow.

Example 8 includes the method of any of examples 1-7 or some other examples herein, further including: receiving, from a network, an indication of a maximum number of bearer flows to be assigned to the AS RB.

Example 9 includes the method of any of examples 1-8 or some other examples herein, wherein transmitting the traffic via the bearer flow includes: assigning a flow identification (ID) number to the bearer flow; and including the flow ID in a packet header.

Example 10 includes the method of any of examples 1-9 or some other examples herein, wherein the packet header is a radio link control header or a medium access control sub-header.

Example 11 includes the method of any of examples 1-10 or some other examples herein, wherein the bearer flow is a default bearer flow with a default configuration.

Example 12 includes the method of any of examples 1-11 or some other examples herein, wherein the traffic is a first traffic, the bearer flow is a first bearer flow, the AS RB is a first AS RB, and the method further includes: receiving second traffic to be transmitted via a second AS RB; mapping the second traffic to a second bearer flow assigned to the second AS RB; and transmitting the second traffic via the second bearer flow.

Example 13 includes the method of any of examples 1-12 or some other examples herein, the method further includes: detecting a release condition; and releasing the bearer flow based on detecting the release condition.

Example 14 includes the method of any of examples 1-13 or some other examples herein, the method further including: detecting a local condition; and mapping the traffic to the bearer flow based on detecting the local condition, wherein the local condition is a number of active data traffic flows, application metadata associated with the traffic, a link quality, a block error rate, a congestion metric, or a queue size.

Example 15 includes the method of any of examples 1-14 or some other examples herein, wherein the bearer flow is a first bearer flow and the method further includes detecting a change in the local condition; and mapping the traffic to a second bearer flow assigned to the AS RB based on detecting the change in the local condition.

Example 16 includes the method of any of examples 1-15 or some other examples herein, wherein the traffic is uplink data traffic of a traffic flow and the method further includes: receiving downlink data traffic of the traffic flow via the bearer flow or another bearer flow assigned to the AS RB.

Example 17 includes the method of any of examples 1-16 or some other examples herein, the method further including: receiving an unmapping indication; and unmapping the data traffic from the bearer flow based on the unmapping indication.

Example 18 includes the method of any of examples 1-17 or some other examples herein, wherein a radio link control (RLC) bearer flow control packet data unit (PDU) establishes said mapping, the RLC bearer flow control PDU including a bearer flow identification number, a mapping-start indication, a mapping-end indication, an AS traffic template identification number, or an AS traffic template.

Example 19 includes a method of operating a first device, the method comprising: receiving a data traffic of a first traffic flow from a second device via a first bearer flow, wherein the bearer flow is assigned to an access stratum (AS) radio bearer (RB) by the second device; receiving a data traffic of a second traffic flow via the second bearer flow, the second bearer flow assigned to the AS RB; and processing transmissions and retransmissions associated with the data traffic of the first traffic flow independent from transmissions and retransmissions associated with the data traffic of the second traffic flow.

Example 20 includes the method of example 19 or some other examples herein, further including: detecting a flow identifier (ID) in a packet header of the first traffic flow; determining the bearer flow from the flow ID; and updating a mapping table to indicate that the bearer flow is assigned to the AS BR.

Example 21 includes the method of examples 19 or 20 or some other examples herein, wherein the packet header is a radio link control header or a medium access control sub-header.

Example 22 includes the method of any of examples 19-21 or some other examples herein, wherein the data traffic of the first traffic flow is a first data traffic of the first traffic flow, and the method further includes: receiving a second data traffic of the first traffic flow to be sent to the second device via the AS RB; and transmitting the second data traffic of the traffic flow via the bearer flow or another bearer flow assigned to the AS RB.

Example 23 includes the method of any of examples 19-22 or some other examples herein, wherein the first bearer flow is associated with a first layer 2 (L2) resource set and the second bearer flow is associated with a second L2 resource set.

Example 24 includes the method of any of examples 19-23 or some other examples herein, further including: receiving from the second device an indication of ending of the traffic flow; and removing a mapping of the traffic flow to the bearer flow based on the indication of the ending of the traffic flow.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example include a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method to be implemented by a component of a network element, the method comprising:
processing traffic to be transmitted via an access stratum (AS) radio bearer (RB);
mapping the traffic to a bearer flow assigned to the AS RB; and
generating a packet associated with the traffic to be transmitted via the bearer flow.

2. The method of claim 1, further comprising:
assigning the bearer flow to the AS RB; and
initializing, based on said assigning of the bearer flow to the AS RB, a layer 2 (L2) resource set associated with the bearer flow based on a configuration of the AS RB.

3. The method of claim 2, wherein the L2 resource set includes sequence numbers, state variables, or timers.

4. The method of claim 3, further comprising:
associating, at a MAC layer, an AS RB logical channel ID with a plurality of bearer flows mapped to the AS RB.

5. The method of claim 1, wherein the traffic is a first service data flow (SDF), the bearer flow is a first bearer flow, the packet is a first packet, and the method further comprises:
processing a second SDF;
assigning a second bearer flow to the AS RB;
mapping the second SDF to the second bearer flow; and
generating a second packet associated with the second SDF to be transmitted via the second bearer flow,
wherein the first bearer flow is associated with a first layer 2 (L2) resource set and the second bearer flow is associated with a second L2 resource set.

6. The method of claim 5, wherein transmissions and retransmissions associated with transmitting the first SDF are independent from transmissions and retransmissions associated with the second SDF.

7. The method of claim 5, wherein:
the first bearer flow is associated with a first packet data convergence protocol (PDCP) entity and the first PDCP entity includes a first hyper frame number (HFN);
the second bearer flow is associated with a second PDCP entity and the second PDCP entity includes a second HFN; and
the method further comprises:
maintaining the first HFN independent from the second HFN,
maintaining the first HFN at initializing, releasing, or unmapping of the first bearer flow, and
maintaining the second HFN at initializing, releasing, or
unmapping of the second bearer flow.

8. The method of claim 1, further comprising:
processing an indication received from a network, the indication associated with a maximum number of bearer flows to be assigned to the AS RB.

9. The method of claim 1, wherein transmitting the traffic via the bearer flow comprises:
assigning a flow identification (ID) number to the bearer flow; and
including the flow ID in a packet header.

10. The method of claim 1, wherein the traffic is a first traffic, the bearer flow is a first bearer flow, the AS RB is a first AS RB, the packet is a first packet, and the method further comprises:
processing second traffic to be transmitted received via a second AS RB;
mapping the second traffic to a second bearer flow assigned to the second AS RB; and
generating a second packet associated with the second traffic to be transmitted via the second bearer flow.

11. The method of claim 1, further comprising:
detecting a release condition; and
releasing the bearer flow based on detecting the release condition.

12. The method of claim 1, wherein the traffic is uplink data traffic of a traffic flow and the method further comprises:
processing downlink data traffic of the traffic flow received via the bearer flow or another bearer flow assigned to the AS RB.

13. The method of claim 1, further comprising:
process an unmapping indication; and
unmapping the traffic from the bearer flow based on the unmapping indication.

14. One or more non-transitory, computer-readable media having instructions that, when executed by one or more processors, cause a component of a first device to:
process data traffic of a first traffic flow from a second device via a first bearer flow, wherein the bearer flow is assigned to an access stratum (AS) radio bearer (RB) by the second device;
process data traffic of a second traffic flow via the second bearer flow, the second bearer flow assigned to the AS RB; and
process transmissions or retransmissions associated with the data traffic of the first traffic flow independent from transmissions or retransmissions associated with the data traffic of the second traffic flow.

15. The one or more non-transitory, computer-readable media of claim 14, wherein the instructions further cause the component of the first device to:
detect a flow identifier (ID) in a packet header associated with the first traffic flow;
determine the bearer flow from the flow ID; and
update a mapping table to indicate that the bearer flow is assigned to the AS BR.

16. The one or more non-transitory, computer-readable media of claim 14, wherein the data traffic of the first traffic flow is a first data traffic of the first traffic flow, and the instructions further cause the component of the first device to:
process a second data traffic of the first traffic flow to be sent to the second device via the AS RB; and
generate a packet associated with the second data traffic of the traffic flow to be transmitted via the bearer flow or another bearer flow assigned to the AS RB.

17. The one or more non-transitory, computer-readable media of claim 14, instructions further cause the component of the first device to:
process an indication of ending of the traffic flow, the indication received from the second device; and
removing a mapping of the traffic flow to the bearer flow based on the indication of the ending of the traffic flow.

18. An apparatus to be implemented in a user network element, the apparatus comprising:
processing circuitry to:
process traffic to be transmitted via an access stratum (AS) radio bearer (RB);
map the traffic to a bearer flow assigned to the AS RB; and
generate a transmission associated with the traffic to be transmitted via the bearer flow; and
interface circuitry coupled with the processing circuitry, the interface circuitry to communicatively couple the processing circuitry to a component of the UE.

19. The apparatus of claim 18, wherein the processing circuitry further to:
assign the bearer flow to the AS RB;
initialize, based on said assigning of the bearer flow to the AS RB, a layer 2 (L2) resource set associated with the bearer flow based on a configuration of the AS RB, the L2 resource set includes sequence numbers, state variables, or timers; and
associate, at a MAC layer, an AS RB logical channel ID with a plurality of bearer flows mapped to the AS RB.

20. The apparatus of claim 18, wherein the traffic is a first service data flow (SDF), the bearer flow is a first bearer flow, and the processing circuitry further to:
process a second SDF;
assign a second bearer flow to the AS RB;
map the second SDF to the second bearer flow; and
generating a packet associated with the second SDF to be transmitted via the second bearer flow, the first bearer flow is associated with a first layer 2 (L2) resource set and the second bearer flow is associated with a second L2 resource set.
